(19) United States
(12) Patent Application Publication
(10) Pub. No.: US 2004/0001223 A1
(43) Pub. Date: Jan. 1, 2004

(54) Service system, server, and client application

(76) Inventor: Keisuke Tanaka, Kanagawa-ken (JP)

Correspondence Address: BIRCH STEWART KOLASCH & BIRCH, PO BOX 747, FALLS CHURCH, VA, 22040-0747, US

(21) Appl. No.: 10/422,723

(22) Filed: Apr. 25, 2003

(30) Foreign Application Priority Data
Apr. 26, 2002 (JP) (PAT)125328/2002

(51) Int. Cl. G06F 15/00

(52) U.S. Cl. 358/1.15

(57) ABSTRACT

A service can be differentiated according to a distribution route of a client application. When a printing order is placed from a print server via a personal computer installed with a client application attached with a setting file including distribution route information, the client application sends the setting file to the print server. A service provision unit in the print server selects a distribution route service from a distribution route service database based on the distribution route information, and receives the printing order from the personal computer while displaying the selected service. An invoicing unit of the server invoices a user by discounting a charge according to the distribution route service.

### BACKGROUND OF THE INVENTION

1. Field of the Invention

The present invention relates to a service system that enables selective provision of a desired one of services and to a server and a client application used therefor.

2. Description of the Related Art

Client applications for requesting services from servers are distributed as supplements of magazines or on the street for promoting usage of the services, and systems that provide such services are being used. When a user actually requests a service from a server through an access to the server by installing a client application distributed in the above manner in a terminal, the client application operates so as to send setting information for using the service and version information of the client application to the server. The server refers to the setting information and the version information of the client application in order to set the content of the service and to deal with a difference in the version of the client application.

Such a service system is applied to the filed of photograph printing, and a photograph printing service system has been proposed. In the system, a user uses a client application distributed for a charge or no charge, and accesses a server (a print server in this case) that stores photograph image data obtained by photography with a digital camera or obtained in a mini-laboratory by scanning a photographic film. The user places a photograph print order by inputting printing setting such as a print size and a quantity regarding the photograph image data. The print server sends the photograph image data and the printing setting to a mini-laboratory or the like that generates a photograph print.

Meanwhile, such a client application that requests a service through an access to a server is often distributed to a large number of unspecified people. Therefore, a provider of a service wishes to differentiate the service by a distribution route of the client application. For example, some kind of privilege service can be provided in some cases in response to an access using an application distributed as a supplement of a magazine. In other cases, distribution routes of a client application used for an access may be subjected to statistics so that marketing information can be gathered for understanding user needs. In this manner, a better service can be provided and use of the service can be promoted.

However, a conventional client application does not have information representing how the client application was distributed, although the client application has setting information for using a service and version information of the client application. Therefore, a server that provides a service needs an input of a distribution route by a user in order to differentiate the service according to the distribution route, for example. Consequently, the user is troubled by the input and reliability of information on the distribution route is not sufficiently high. For this reason, differentiation of the service with accuracy according to the distribution route has been difficult.

Furthermore, a service provider needs to occasionally carry out a special service such as a campaign for promotion of an ordinary service. In this case, a server that provides the special service is necessary in addition to a server that carries out the ordinary service. Therefore, more cost and development time become necessary and efficiency of the service system is reduced.

### SUMMARY OF THE INVENTION

The present invention has been conceived based on consideration of the above circumstances. An object of the present invention is therefore to provide a service system, a server, and a client application that enable differentiation of a service according to a distribution route of the client application and improvement in efficiency of providing a special service such as a campaign or a privilege service.

A service system of the present invention is a service system comprising:

a terminal that makes a service request by using a client application distributed via various routes to a large number of unspecified users; and

a server that selectively provides various types of services according to the service request of the terminal. The client application is attached with service specification information for specifying one or more of the types of services and

the terminal sends the service specification information to the server for making the service request. The server provides the service or services specified by the service specification information sent from the terminal and the service specification information includes one of the distribution routes corresponding to the client application used by the terminal.

In other words, the client application used in the present invention is attached with the service specification information including the distribution route thereof. When the service request is sent to the server via the terminal installed with the client application, the service or services to be provided by the server in response to the service request are specified by the service specification information sent thereto.

The distribution routes refer to information used in the present system to represent how the client application is distributed, such as routes by which the client application of the present invention is distributed, or the type of the routes, properties thereof, and area information. For example, the distribution routes refer to the name of a magazine in the case where the client application is distributed as a supplement of the magazine, the type of the magazine (such as a computer-related magazine or a fashion-related magazine, or a photograph-related magazine), the name of a store at which the client application is distributed, the type of the store (such as home appliance store or a DPE store), and an area in which the client application is distributed (such as the East coast, the West coast, or the Midwest).

The service specification information refers to information for specifying one or more of the services that can be provided by the server of the service system of the present invention. As has been described above, the object of the present invention is to enable service differentiation according to the distribution route of the client application. Therefore, the distribution routes are listed first as the service specification information. The present invention also aims to efficiently carry out a special service. Therefore, the type of a privilege service, the expiration date of the privilege service, an effective period of the privilege service, and limitation on use of the privilege service can be listed as the service specification information that can specify the special service, for example. The service specification information only with the distribution route information may be used as the service specification information to use an ordinary service.

The services provided by the server of the present invention include not only a service provided directly to a user, such as a photograph printing order reception service, but also a service that is not provided directly to a user but provided according to the service specification information such as the distribution route information. For example, a direct service refers to discounting a service charge for a user who requests a service by using a client application distributed via a specific magazine among users who request the service by using the client application distributed as supplements of magazines. An indirect service refers to displaying a banner advertisement of the specific magazine or link information thereto when the number of users who use the service by the client application distributed via the specific magazine reaches a predetermined number, for example.

The service system of the present invention can be applied to a photograph printing system to carry out a photograph printing service. In this case, the client application is a program to place a photograph printing order and the server is used as a print server to carry out the photograph printing service.

A server of the present invention is a server for selectively providing various types of services according to a service request sent from a terminal that uses a client application distributed to a large number of unspecified users via various distribution routes and that sends the service request together with service specification information including one of the distribution routes corresponding to the client application. The server comprises:

reading means for reading the service specification information;

service selection means for selecting one or more of the services specified by the service specification information obtained by the reading means; and

service execution means for providing the service or services selected by the service selection means.

A client application of the present invention is a client application distributed to a large number of unspecified users via various distribution routes, and the client application is attached with service specification information including one of the distribution routes corresponding to the client application so that

the client application causes a computer to make a service request by sending the service specification information to a server that provides a service or services specified by the service specification information.

According to the service system of the present invention, when the terminal makes the service request from the server by using the client application attached with the service specification information including the distribution route thereof, the terminal sends the service specification information to the server, and the server provides the service or services specified by the service specification information. In this manner, service differentiation can be carried out according to the distribution routes of the client application to a large number of unspecified users. Therefore, use of the services can be promoted and marketing information can be analyzed with accuracy.

If the information on a privilege service other than an ordinary service carried out by the server is attached to the client application as the service specification information and sent at the time the terminal sends the service request, the server can understand the privilege service that is available to the terminal (the client application) by referring to the service specification information. Therefore, if the server can be set to provide the service according to the information on the privilege service, no new server is necessary at the time of introducing a new service, which is efficient.

### BRIEF DESCRIPTION OF THE DRAWINGS

FIG. 1 is a block diagram showing a configuration of a printing service system according to an embodiment of the present invention;

FIG. 2 shows a structure of a setting file attached to a client application used in the printing service system shown in FIG. 1;

FIG. 3 is a block diagram showing a configuration of a print server 100 in the printing service system;

FIG. 4 is a flow chart showing the operation of personal computers 10 and 20 in the printing service system;

FIG. 5 is a flow chart showing the operation of the print server 100 shown in FIG. 3;

FIG. 6 is a Web page illustrating the operation of a service provision unit 130 in the print server 100;

FIG. 7 is a Web page illustrating the operation of the service provision unit 130;

FIG. 8 is a Web page illustrating the operation of the service provision unit 130; and

FIG. 9 is a Web page illustrating the operation of the service provision unit 130.

### DESCRIPTION OF THE PREFERRED EMBODIMENT

Hereinafter, an embodiment of the present invention will be explained with reference to the accompanying drawings.

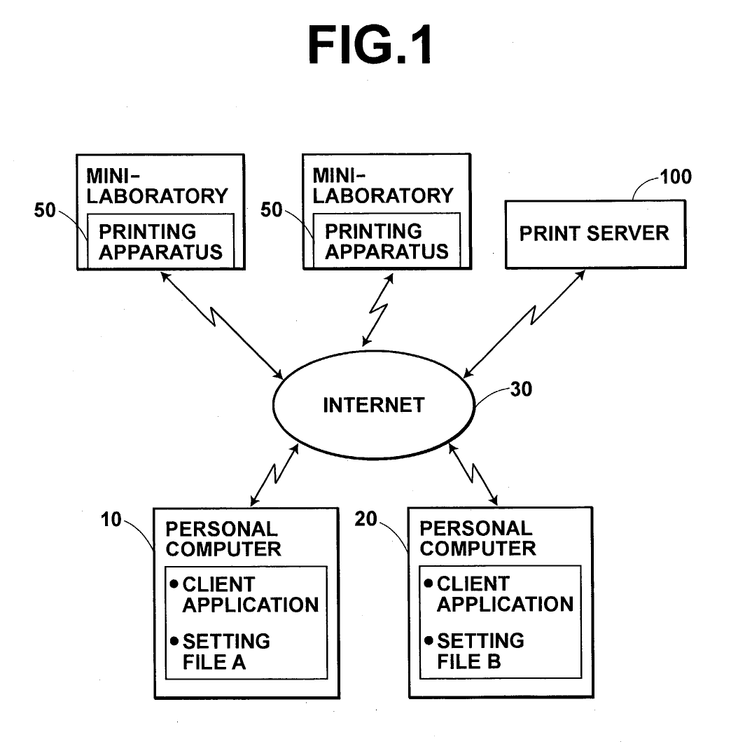

FIG. 1 is a block diagram showing a configuration of a printing service system according to an embodiment of a client application, a server, and a service system of the present invention. As shown in FIG. 1, the printing service system in this embodiment comprises personal computers 10 and 20 acting as terminals, a print server 100 for providing a service such as printing order reception, and printing apparatuses 50 installed respectively in mini-laboratories and used for printing image data regarding which a printing order is received by the print server 100. The personal computers 10 and 20 and the printing apparatus 50 are connected to the print server 100 via the Internet 30.

The personal computers 10 and 20 have a client application installed therein for placing a printing order from the print server 100. The client application of the personal computer 10 has a setting file A while the client application of the personal computer 20 has a setting file B.

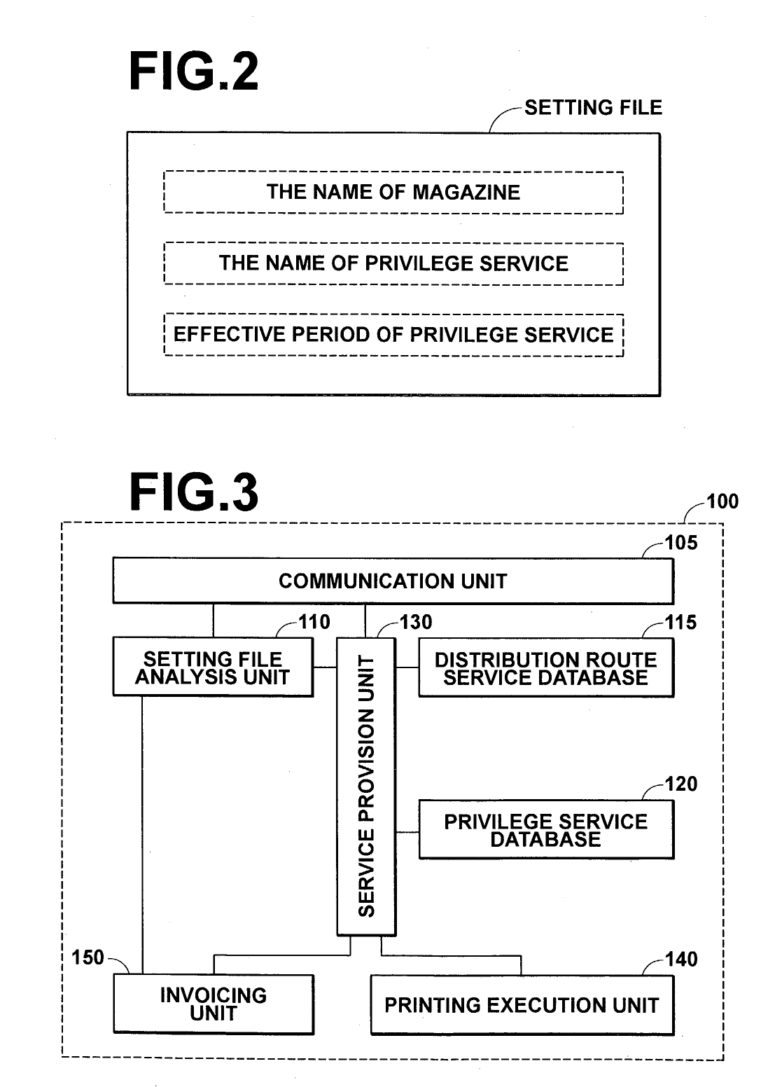

The client application installed in the personal computers 10 and 20 is distributed as supplements of magazines A and B. FIG. 2 shows a configuration of the setting files attached to the client application. The setting files A and B attached to the client applications respectively have information representing the name of the corresponding magazine as a distribution route, the name of a privilege service available to the client application, and an effective time period of the privilege service. For example, the setting file A has the information comprising “magazine A”, “privilege service 1”, and “from Jan. 1 to 10, 2002”, while the setting file B has the information comprising “magazine B”, “no privilege service”, and “no effective period”. The client application sends the corresponding setting file attached thereto to the print server 100 upon an access to the print server 100 via the personal computer 10 or 20 for placing a printing order.

FIG. 3 is a block diagram showing a configuration of a print server 100 used in the printing service system in this embodiment. As shown in FIG. 3, the print server 100 comprises a communication unit 105, a distribution route service database 115, a privilege service database 120, a setting file analysis unit 110, a service provision unit 130, a printing execution unit 140, and an invoicing unit 150. The communication unit 105 carries out communication with the personal computers 10 and 20 and the printing apparatuses 50 in the mini-laboratories via the Internet 30. The distribution route service database 115 stores the content of services provided according to distribution routes of the client application (hereinafter referred to as the distribution route services). The privilege service database 120 stores the content of privilege services. The setting file analysis unit 110 reads and analyzes the setting files A and B sent from the personal computers 10 and 20. The service provision unit 130 displays in a Web page the content of one or more of the distribution route services and the privilege services selected from the distribution route service database 115 and the privilege service database 120 according to the distribution route information and the name of the privilege service analyzed by the setting file analysis unit 110. The service provision unit 130 also receives a printing order. The printing execution unit 140 sends via the communication unit 105 the image data regarding which the printing order is received by the service provision unit 130 and printing setting such as a quantity and a print size regarding the image data to one of the printing apparatuses 50 for printing (hereinafter referred to as the printing apparatus 50). The invoicing unit 150 invoices a user according to the content of the printing order received by the service provision unit 130, based on the content of the selected distribution route service or services and the selected privilege service or services. The service provision unit 130 has an image data storage unit for storing the image data uploaded by the user at the time the user places the printing order.

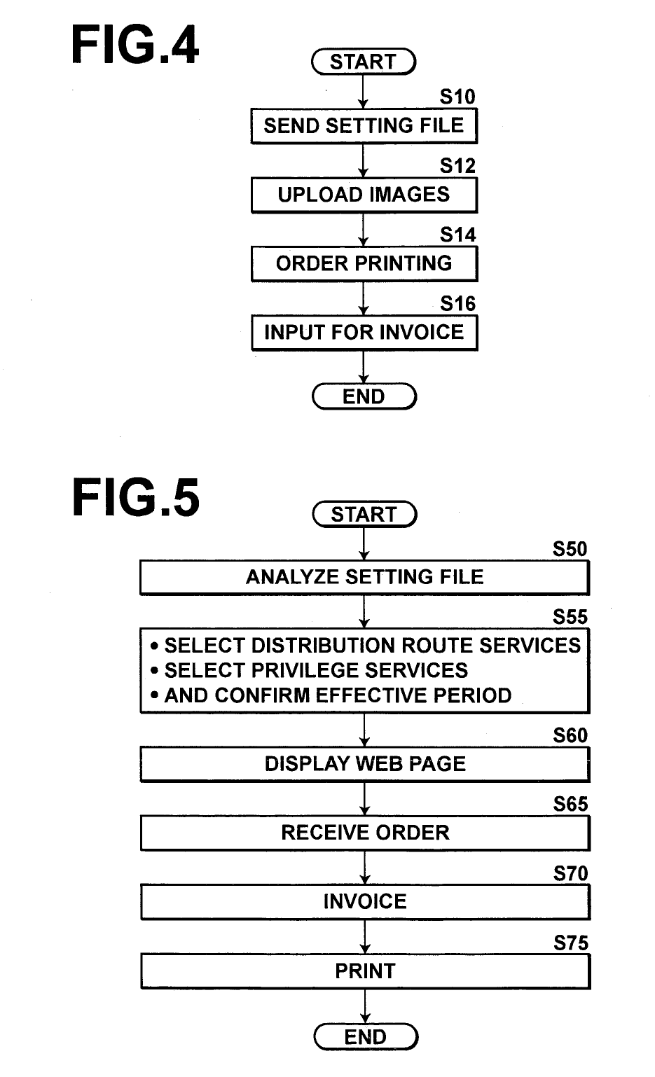

The operation of the printing service system in this embodiment will be explained in detail with reference to FIGS. 4 and 5.

FIG. 4 is a flow chart showing the operation of the terminals (personal computers 10 and 20) in the printing service system in this embodiment. For the sake of simpler explanation, the operation of the personal computer 10 will be explained as an example. As shown in FIG. 4, when the user accesses the print server 100 via the personal computer 10 for placing the printing order, the client application installed in the personal computer 10 sends the setting file A to the print server 100 (Step S10). The user uploads the image data to be printed (Step S12) via the Web page (which will be explained later in detail) provided by the service provision unit 130 in the print server 100 that receives the setting file A. The user also places the printing order by inputting the printing setting such as the quantity and the print size regarding the image data (Step S14). The user then selects a method of payment charged by the print server 100, and inputs information necessary for the selected payment method (Step S16). The user then logs off the system to end the procedure.

FIG. 5 is a flow chart showing the operation of the print server 100 in the printing service system. Hereinafter, service provision in response to the access from the personal computer 10 will be explained.

Upon the access from the personal computer 10 via the communication unit 105, the print server 100 receives the setting file A attached to the client application, and the setting file analysis unit 110 analyzes the setting file A. The information is then obtained on the distribution route of the client application installed in the personal computer 10 and the content and the effective period of the privilege service or services to the user. The information is sent to the service provision unit 130 and the invoicing unit 150 (Step S50). The service provision unit 130 selects the distribution route service or services and the privilege service or services from the distribution route service data base 115 and the privilege service database 120 according to the distribution route information and the privilege service information regarding the client application obtained by the setting file analysis unit 110, and confirms the effective period of the privilege service or services to be provided to the user of the client application (Step S55). The service provision unit 130 displays the Web page for printing order reception including the distribution route service or services and the privilege service or services that have been selected (Step S60), in order to receive the printing order (Step S65). The printing order reception by the service provision unit 130 will be explained below with reference to the Web page provided by the service provision unit 130 in response to the access from the personal computer 10.

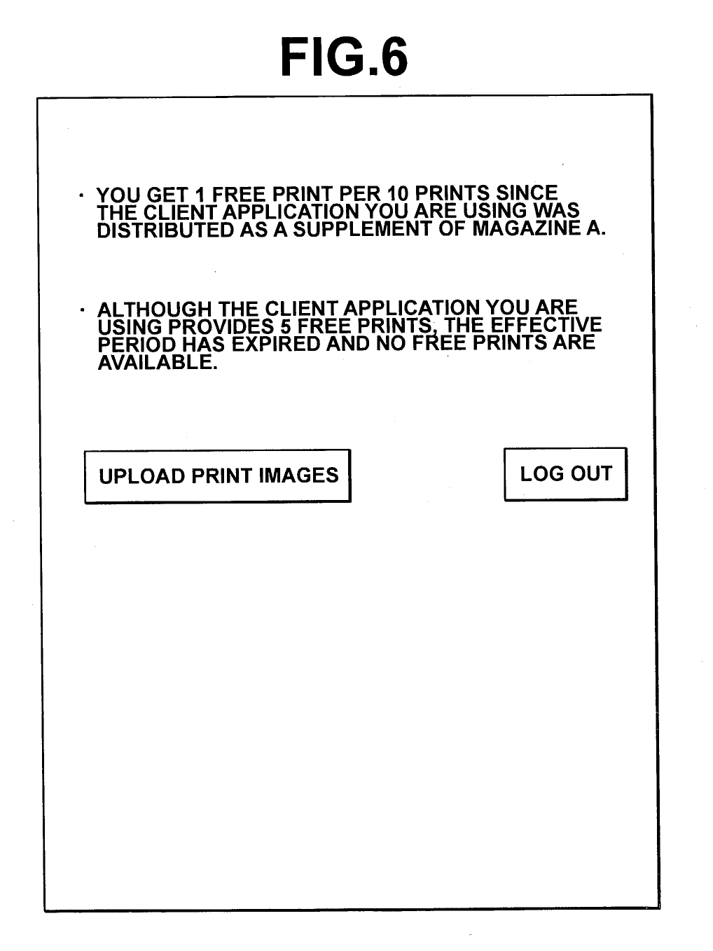

FIG. 6 is the Web page displayed on the personal computer 10 by the service provision unit 130. As has been described above, the content of the setting file A of the client application comprises “magazine A” as the distribution route information, “privilege service 1” as the name of the privilege service, and “Jan. 1 to 10, 2002” as the effective period of the privilege service. Therefore, the service provision unit 130 searches the distribution route database 115, and selects two of the distribution route services “1 free print per 10 prints” and “displaying a banner advertisement of the magazine A”. Since the name of the privilege service included in the setting file A is “privilege service 1”, the service provision unit 130 searches the privilege service database 120 to select the privilege service 1, “5 free prints”. However, the service provision unit 130 confirms the information on the effective period “Jan. 1 to 10, 2002” attached to the setting file A, and recognizes that the effective period for the user of the client application has expired. Therefore, the service provision unit 130 displays on the personal computer 10 the content of the services and a “Upload Print Images” button for uploading the image data to be printed, as shown by the page in FIG. 6.

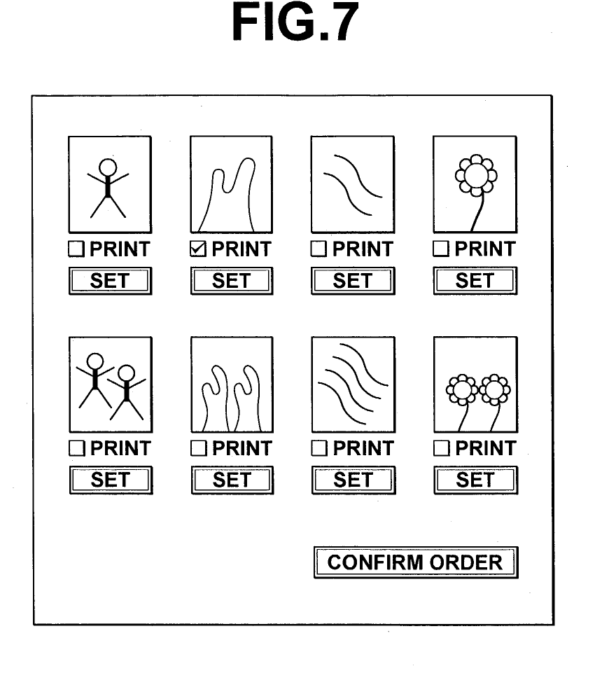

FIG. 7 is a Web page displayed by the service provision unit 130 after the user of the personal computer 10 clicks the “Upload Print Images” button in the page shown in FIG. 6 for uploading the image data.

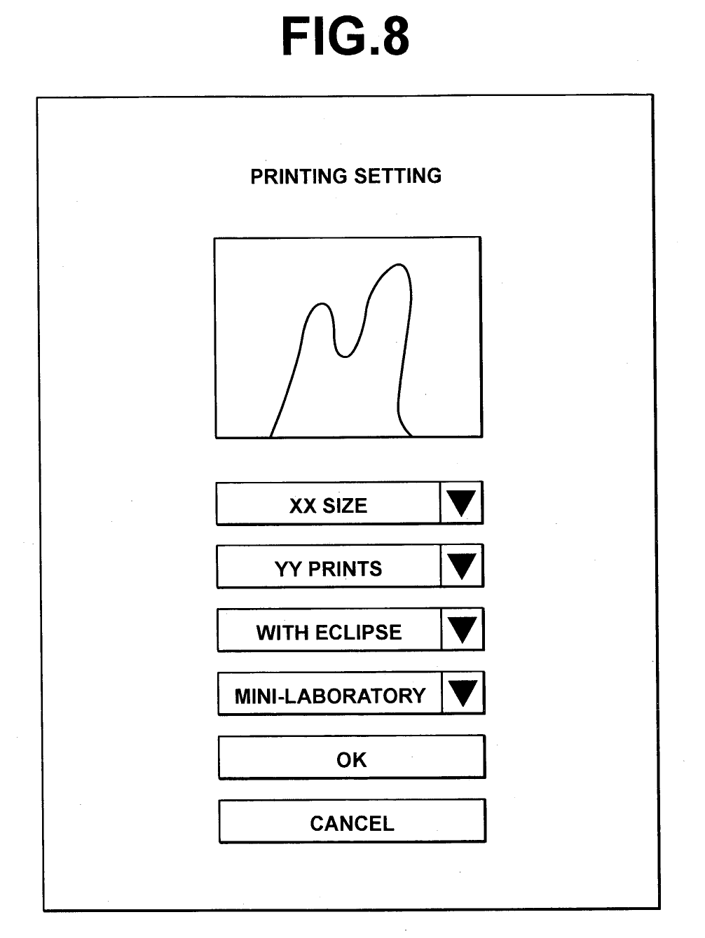

The service provision unit 130 stores the image data uploaded from the personal computer 10 in the image data storage unit that is not shown. At the same time, the service provision unit 130 displays images represented by the image data and “Print” check boxes and “Set” buttons under the respective images, as shown in FIG. 7. The user of the personal computer 10 can specify any one of the images as a printing target by selecting the corresponding one of the “Print” check boxes. The “Set” buttons under the respective images are used for printing setting regarding the corresponding images. When one of the “Set” buttons is clicked, the service provision unit 130 displays a printing setting page shown in FIG. 8. The user can input the print size, the print quantity, presence or absence of eclipse, and an agency in this page. When an “OK” button is clicked, printing setting for the corresponding image is completed and the service provision unit 130 changes the printing setting page to the page shown in FIG. 7. When a “Cancel” button is clicked, the printing setting for the corresponding image is cancelled, and the service provision unit 130 changes the printing setting page to the page shown in FIG. 7.

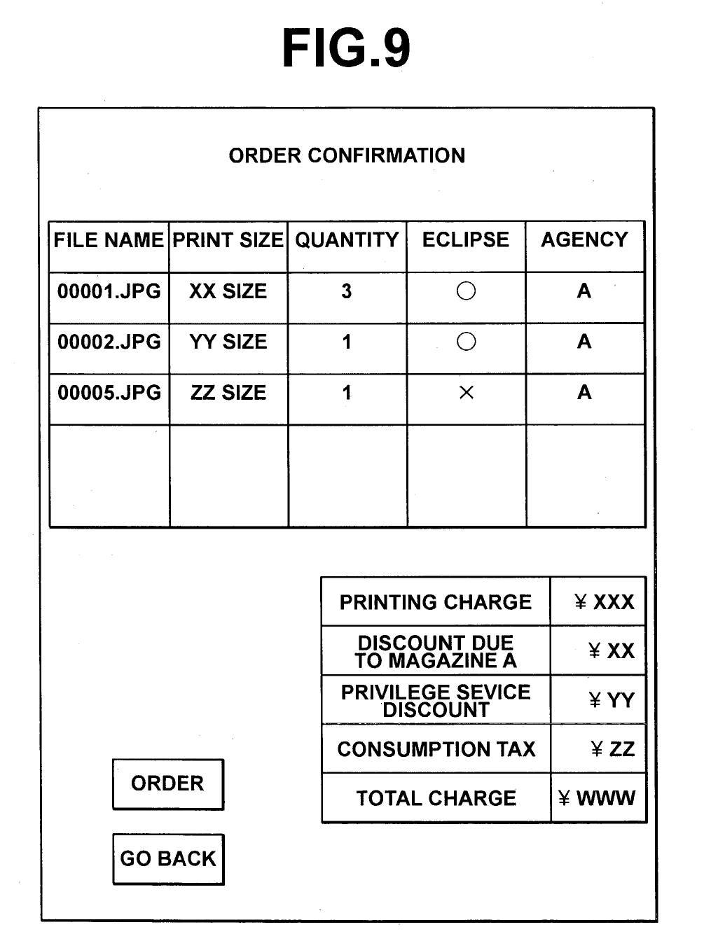

When a “Confirm Order” button is clicked at the bottom of the page shown in FIG. 7, the invoicing unit 150 calculates a printing charge corresponding to the content of printing, a discount according to one of the two distribution route services and the privilege service, and a total charge, and sends the charges to the service provision unit 130. The service provision unit 130 collectively displays the charges calculated by the invoicing unit 150 together with the printing setting by the user in an order confirmation page shown in FIG. 9. The user can confirm the printing setting and the charges in this page. When the user clicks an “Order” button, the order is confirmed. If a “Go Back” button is clicked, the service provision unit 130 changes the order confirmation page to the page shown in FIG. 7 to enable the user to input the printing setting again.

After the service provision unit 130 receives the printing order, the invoicing unit 150 prompts the user to input the information necessary for invoicing (such as information on a credit card number) in the flow chart shown in FIG. 5 (Step S70). After the invoicing unit 150 completes the invoice procedure, the printing execution unit 140 in the print server 100 reads the image data from the image data storage unit of the service provision unit 130 as the printing target regarding the printing order received by the service provision unit 130. The printing execution unit 140 then sends the image data together with the printing setting such as the print size and quantity to the printing apparatus 50 to cause the printing apparatus 50 to print the image data (Step S75).

The printing apparatus 50 obtains a print or prints by printing the image data according to the printing setting.

Although the services provided by the print server 100 to the user of the personal computer 10 have been explained above, there are two distribution route services “1 free print per 10 prints” and “displaying a banner advertisement of the magazine A” for the distribution route “magazine A”, as has been described above. Therefore, the service provision unit 130 also displays the banner advertisement of the magazine A in the page shown in FIG. 6 at the time of another access thereafter.

The operation of the print server 100 has been explained with reference to the example of the access from the personal computer 10. For an access from the personal computer 20, the print server 100 provides one or more of the distribution route services and privilege services selected from the distribution route service database 115 and from the privilege service database 120 (actually, no privilege service in this case) according to the setting file B attached to the client application installed in the personal computer 20.

As has been described above, according to the printing service system in this embodiment, the client application for placing a printing order from the print server 100 sends the distribution route information attached thereto to the print server 100 via the terminal (the personal computer 10 or 20). Therefore, the print server 100 provides the services according to the distribution route of the client application, based on the distribution route information.

The client application also sends the information representing the privilege service or services to the print server 100 together with the distribution route information. Therefore, the print server 100 does not need to be configured newly when a new privilege service is provided. Only by adding the content of the new privilege service to the privilege service database 120, the new privilege service can be provided, which is efficient.

Although the printing service system of a preferable embodiment of the present invention has been explained in the above, the present invention is not limited to the embodiment, and many modifications can be made thereto within the scope of the present invention.

For example, the print server 100 prints the image data by sending the image data to one of the mini-laboratories. However, the image data may be stored in a hard disc or the like and provided to the printing apparatus 50 upon regular inquiry by the printing apparatus 50.

Furthermore, the service system, the client application, and the server of the present invention are not limited to be used in the printing service system shown in FIG. 1. The present invention can be applied to any service system that differentiates a service according to a distribution route of the client application that requests a service from the server.

Moreover, in the printing service system shown in FIG. 1, the print server 100 only provides services to the user and to the distribution route (such as the magazine) by using the distribution route information. However, the distribution route information can also be used for marketing information analysis, for example.

What is claimed is:

1. A service system comprising:
a terminal for making a service request by using a client application distributed to a large number of unspecified users via various routes; and
a server for selectively providing various types of services according to the service request of the terminal, the client application being attached with service specification information for specifying one or more of the types of services, wherein
the terminal sends the service specification information to the server at the time of making the service request and
the server provides the service or services specified by the service specification information sent from the terminal, and wherein the service specification information includes one of the distribution routes corresponding to the client application used by the terminal.

2. A service system as defined in claim 1, wherein the client application is a program to place a photograph printing order and
the server is a print server for carrying out a photograph printing service.

3. A service system as defined in claim 1, wherein the service specification information includes information on a privilege service.

4. A service system as defined in claim 2, wherein the service specification information includes information on a privilege service.

5. A server for selectively providing various types of services according to a service request sent from a terminal that uses a client application distributed to a large number of unspecified users via various distribution routes and that sends the service request together with service specification information including one of the distribution routes corresponding to the client application used by the terminal, the server comprising:
reading means for reading the service specification information;
service selection means for selecting one or more of the services specified by the service specification information obtained by the reading means; and
service execution means for providing the service or services selected by the service selection means.

6. A client application distributed to a large number of unspecified users via various distribution routes, wherein the client application is attached with service specification information including one of the distribution routes corresponding to the client application and
causes a computer to make a service request while sending the service specification information to a server that provides a service or services specified by the service specification information.
